(19) United States
(12) Patent Application Publication
(10) Pub. No.: US 2017/0109329 A1
(43) Pub. Date: Apr. 20, 2017

(54) METHOD, SYSTEM AND APPARATUS FOR PROCESSING A DOCUMENT

(71) Applicant: CANON KABUSHIKI KAISHA, Tokyo (JP)

(72) Inventor: PETER VINCENT WYATT, Hunters Hill (AU)

(21) Appl. No.: 15/293,098

(22) Filed: Oct. 13, 2016

(30) Foreign Application Priority Data
Oct. 16, 2015 (AU) 2015243069

(51) Int. Cl. G06F 17/22; G06F 17/27

(52) U.S. Cl. CPC G06F 17/2247; G06F 17/2785

(57) ABSTRACT

A method of processing a document described by a page description language (PDL) data structure in a PDL coordinate space. The PDL data structure describes independent image objects of the document is received. Each of the independent image objects is described in the PDL data structure by associating image data with at least one attribute of the corresponding independent image object, each independent image object being independently placed in the PDL coordinate space. A plurality of the independent image objects marked, in the PDL data structure, as forming a unified logical image and one or more of the identified independent image objects are adjusted independently of each other based on the corresponding attributes.

### REFERENCE TO RELATED PATENT APPLICATION(S)

This application claims the benefit under 35 U.S.C. §119 of the filing date of Australian Patent Application No. 2015243069, filed Oct. 16, 2015, hereby incorporated by reference in its entirety as if fully set forth herein.

### TECHNICAL FIELD

The present disclosure relates to data encoding formats for image data exported by electronic devices and, in particular, to a data structure encoding one or more independent image objects that are to be processed as a unified logical image. The present disclosure also relates to a method, apparatus and system for processing a document described by a page description language (PDL) data structure in a PDL coordinate space. The present disclosure also relates to a computer program product including a computer readable medium having recorded thereon a computer program for processing a document described by a PDL data structure in a PDL coordinate space.

### BACKGROUND

Modern electronic devices are increasingly becoming interconnected to form networks of devices. The devices are also gaining additional functionality and utility as more modes of interconnection are enabled. Often described as forming an “Internet of Things”, such networks are valued for their ability to bring about new uses and possibilities for existing technologies as the devices are combined. The basis for the utility of such interconnected devices is their interoperability: the ability to send, receive, use and re-use data and commands between different devices in a network. Interoperability, in turn, is built upon shared data formats, removing the need for each device on a network to translate data or commands from some other device's specific format to their own.

Electronic and computing devices deployed on interconnected networks are often imaging devices, having the capability to capture, generate, process and/or display electronic image data. Device independent page description languages, including PDF (Portable Document Format) as defined by International Standard Organisation (ISO) standard, ISO 32000-1:2008, are ideally positioned to act as a convenient exchange format for people and machines for electronic image data produced by interconnected devices. Image data encoded in device independent page description languages, such as PDF, are conveniently packaged as a readily transportable artefact, and can be widely distributed and displayed independently of the device that originally generated the image data. Furthermore, PDF acts as a presentation format for delivering image data in a human readable form, as well as being machine readable.

Interconnected electronic devices are often extremely limited in available processing and memory resources. When exporting a shareable artefact that includes image data, a resource-limited device may be forced to utilise methods in which a limited buffer for image data is iteratively re-used. Iteratively re-using the limited buffer leads to an exported page description language document characterised by independent abutting image slices or tiles that are intended to form the appearance of a single image. However, when displayed, such independent images can exhibit discontinuities or visible gaps at their boundaries. The discontinuities arise from limitations imposed upon the accuracy by which the position of independent images may be encoded in the device independent page description language. Such discontinuities detract from the overall quality of the shared image artefact produced by the interconnected electronic imaging device. Furthermore, independent images may have an incorrect semantic interpretation, instead of being processed as a single image.

In one method, properties; of received images may be examined. If images have the same properties such as colour depth and are geometrically abutting, then the images with the same properties are assumed to be portions of a larger image and are rendered accordingly so as to avoid discontinuities. However, such heuristic methods can make mistakes and both false positives (joining unrelated images) and false negatives (failing to join related images) are possible.

Another method combines adjacent or nearby images. However, combining adjacent or nearby images is done for performance, as there can be economies in dealing with one image instead of several. Such a combining method focuses on speeding up processing while preserving the appearance of output without attempting to solve the problem of discontinuities due to numerical inaccuracies.

In another method, a container file representing a scene containing multiple images that bear some relationship (e.g., being captured successively) may be used, optionally together with instructions for how to combine the images into a final picture, to process the scene. However, in the container method, there is no attempt to address how to render abutting components of an image into a unified whole image without undue artefacts.

### SUMMARY

It is an object of the present invention to substantially overcome, or at least ameliorate, one or more disadvantages of existing arrangements.

Disclosed are arrangements which allow low resource devices (e.g. scanners, network cameras and sensors), to generate high quality device independent electronic documents as output within the limited memory resources on the low resource device. Particularly, one or more of the disclosed arrangements enable low resource devices to achieve quality of reproduction normally attributed to high-end devices, such as personal computers or servers. One or more of the disclosed arrangements make a low resource device more useful in terms of its functional capabilities and produced output. Moreover, such a technical effect is achieved within the limited memory resources typically available on low resource devices, compared to the memory available on high power devices, thereby facilitating reduction in device cost, integration complexity, and power consumption.

According to one aspect of the present disclosure there is provided a device independent page description language which places multiple independent image objects onto a page, in the vicinity of one another. Each of the independent image objects is associated with an independent image. The independent images are marked as forming a unified logical image, such that at least one of the independent images is adjusted to allow the unified logical image to be consistently processed.

According to another aspect of the present disclosure, there is provided a method of processing a document described by a page description language (PDL) data structure in a PDL coordinate space, the method comprising:

receiving the PDL data structure describing independent image objects of the document, each of the independent image objects being described in the PDL data structure by associating image data with at least one attribute of the corresponding independent image object, each independent image object being independently placed in the PDL coordinate space;

identifying a plurality of the independent image objects marked, in the PDL data structure, as forming a unified logical image; and

adjusting one or more of the identified independent image objects independently of each other based on the corresponding attributes.

According to still another aspect of the present disclosure, there is provided an apparatus for processing a document described by a page description language (PDL) data structure in a PDL coordinate space, the apparatus comprising:

receiving module for receiving the PDL data structure describing independent image objects of the document, each of the independent image objects being described in the PDL data structure by associating image data with at least one attribute of the corresponding independent image object, each independent image object being independently placed in the PDL coordinate space;

identifying module for identifying a plurality of the independent image objects marked, in the PDL data structure, as forming a unified logical image; and

adjusting module for adjusting one or more of the identified independent image objects independently of each other based on the corresponding attributes.

According to still another aspect of the present disclosure, there is provided a system for processing a document described by a page description language (PDL) data structure in a PDL coordinate space, the system comprising:
a memory for storing data and a computer program;
a processor coupled to the memory for executing the computer program, the computer program comprising instructions for:
   receiving the PDL data structure describing independent image objects of the document, each of the independent image objects being described in the PDL data structure by associating image data with at least one attribute of the corresponding independent image object, each independent image object being independently placed in the PDL coordinate space;
   identifying a plurality of the independent image objects marked, in the PDL data structure, as forming a unified logical image; and
   adjusting one or more of the identified independent image objects independently of each other based on the corresponding attributes.

According to still another aspect of the present disclosure, there is provided a computer readable medium having a computer program stored on the medium for processing a document described by a page description language (PDL) data structure in a PDL coordinate space, the program comprising:

code for receiving the PDL data structure describing independent image objects of the document, each of the independent image objects being described in the PDL data structure by associating image data with at least one attribute of the corresponding independent image object, each independent image object being independently placed in the PDL coordinate space;

code for identifying a plurality of the independent image objects marked, in the PDL data structure, as forming a unified logical image; and

code for adjusting one or more of the identified independent image objects independently of each other based on the corresponding attributes.

According to still another aspect of the present disclosure, there is provided a method of generating a document described by a page description language (PDL) data structure in a PDL coordinate space, the method comprising:

receiving a document comprising one or more pages from an electronic device over a communication network, each page comprising a plurality of semantic units, at least a first one of the semantic units being received as a plurality of independent images;

receiving data from the electronic device identifying that the first semantic unit is represented by the plurality independent images; and

generating the PDL data structure describing at least a page of the document, the PDL data structure defining a hierarchy of PDL objects, wherein the independent images are described in the PDL data structure as independent objects in the PDL data structure, wherein the generated PDL data structure comprises a marked content section for the first semantic unit based on the data received from the device to allow consistent processing to be applied to the plurality of independent images.

According to still another aspect of the present disclosure, there is provided an apparatus for generating a document described by a page description language (PDL) data structure in a PDL coordinate space, the apparatus comprising:

document receiving module for receiving a document comprising one or more pages from an electronic device over a communication network, each page comprising a plurality of semantic units, at least a first one of the semantic units being received as a plurality of independent images;

data receiving module for receiving data from the electronic device identifying that the first semantic unit is represented by the plurality independent images; and

generating module for generating the PDL data structure describing at least a page of the document, the PDL data structure defining a hierarchy of PDL objects, wherein the independent images are described in the PDL data structure as independent objects in the PDL data structure, wherein the generated PDL data structure comprises a marked content section for the first semantic unit based on the data received from the device to allow consistent processing to be applied to the plurality of independent images.

According to still another aspect of the present disclosure, there is provided a system for generating a document described by a page description language (PDL) data structure in a PDL coordinate space, the system comprising:
a memory for storing data and a computer program;
a processor coupled to the memory for executing the computer program, the computer program comprising instructions for:
   receiving a document comprising one or more pages from an electronic device over a communication network, each page comprising a plurality of semantic units, at least a first one of the semantic units being received as a plurality of independent images;
   receiving data from the electronic device identifying that the first semantic unit is represented by the plurality independent images; and
   generating the PDL data structure describing at least a page of the document, the PDL data structure defining a hierarchy of PDL objects, wherein the independent images are described in the PDL data structure as independent objects in the PDL data structure, wherein the generated PDL data structure comprises a marked content section for the first semantic unit based on the data received from the device to allow consistent processing to be applied to the plurality of independent images.

According to still another aspect of the present disclosure, there is provided a computer readable medium having a computer program stored thereon for generating a document described by a page description language (PDL) data structure in a PDL coordinate space, the program comprising:

code for receiving a document comprising one or more pages from an electronic device over a communication network, each page comprising a plurality of semantic units, at least a first one of the semantic units being received as a plurality of independent images;

code for receiving data from the electronic device identifying that the first semantic unit is represented by the plurality independent images; and

code for generating the PDL data structure describing at least a page of the document, the PDL data structure defining a hierarchy of PDL objects, wherein the independent images are described in the PDL data structure as independent objects in the PDL data structure, wherein the generated PDL data structure comprises a marked content section for the first semantic unit based on the data received from the device to allow consistent processing to be applied to the plurality of independent images.

According to still another aspect of the present disclosure, there is provided a computer readable medium storing a page description language (PDL) data structure describing a document in a PDL coordinate space, the page description language data structure comprising:

a plurality of independent image objects, each independent image object being described in the PDL data structure by associating image data with at least one attribute of the corresponding independent image section;

at least one image placement command for each independent image object, the at least one image placement command defining a placement of said independent image object in the PDL coordinate space; and

an image marking data structure for associating the plurality of independent image objects, in the PDL coordinate space, with respect to one another in accordance with the image placement commands, the independent image objects being marked as forming a unified logical image to allow consistent processing of the unified logical image by adjusting the marked independent image objects independently of one another.

Other aspects are also disclosed.

### BRIEF DESCRIPTION OF THE DRAWINGS

One or more embodiments of the invention will now be described with reference to the following drawings, in which:

FIGS. 1A and 1B collectively form a schematic block diagram representation of an electronic device upon which described arrangements can be practised;

FIG. 1C is a schematic block diagram the electronic devices of FIG. 1A interconnected via a communications network;

FIG. 2 is a schematic flow diagram showing a data processing flow between two electronic devices;

FIG. 3 shows an example of a displayed image comprising discontinuities;

FIG. 4 is a state diagram showing the form of a data structure for declaring a unified logical image that consists of a plurality of independent images; and

FIG. 5 is a schematic diagram showing an example page description language (PDL) data structure;

FIG. 6 is a flow diagram showing a method of processing a document described by a page description language (PDL) data structure;

Appendix A shows an example sequence of page content drawing commands provided in a portable document format (PDF) page description language (PDL) data structure; and

Appendix B shows independent image objects forming a unified logical image.

### DETAILED DESCRIPTION INCLUDING BEST MODE

The Portable Document Format (PDF) is defined by the International Standard Organisation (ISO) standard, ISO 32000-1:2008, and defines a device independent binary multi-page electronic document format based around an object model. The PDF object model describes a document as a hierarchy of page description language (PDL) objects. The PDF object model describes images, graphics (line art) and text graphical objects, and allows efficient reuse by referencing an object multiple times. PDF content streams are objects containing operators and operands that configure the graphics state and describe how graphical objects are positioned onto pages in a device independent coordinate system. Content streams of operators and operands are expressed as American Standard Code for Information Interchange (ASCII) text. The Microsoft XML Paper Specification (XPS) is another similar page description language.

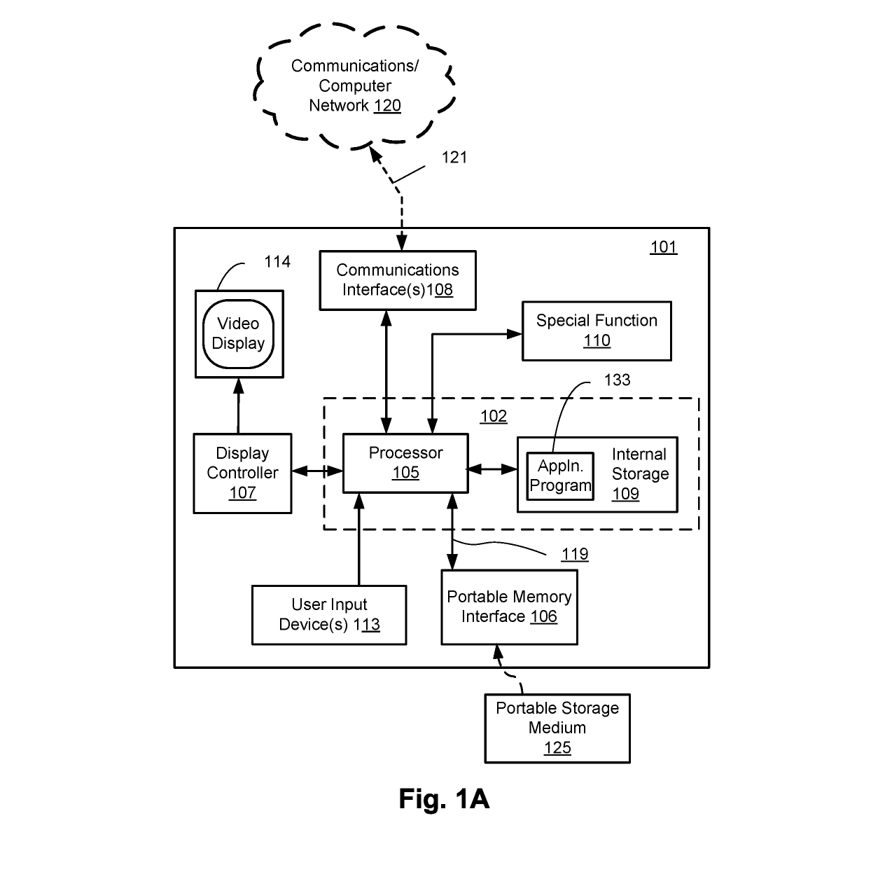

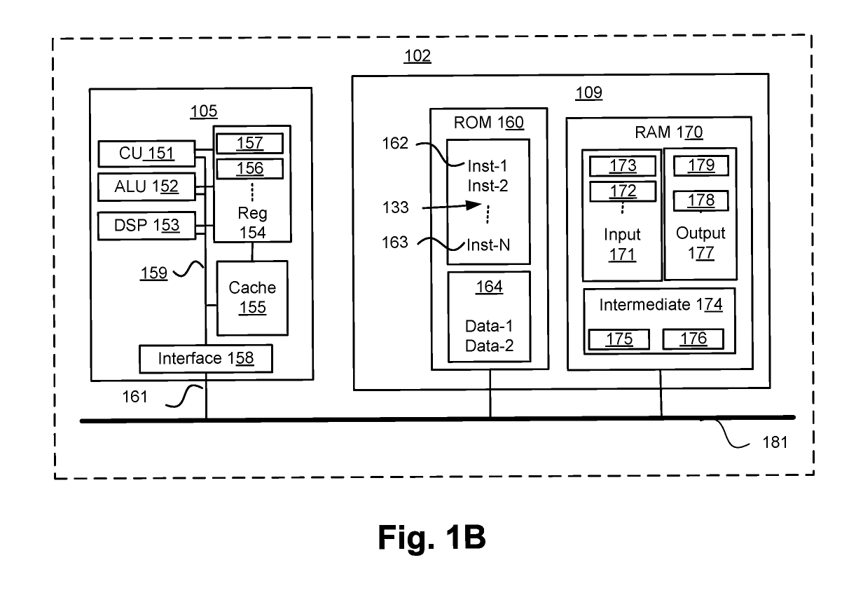

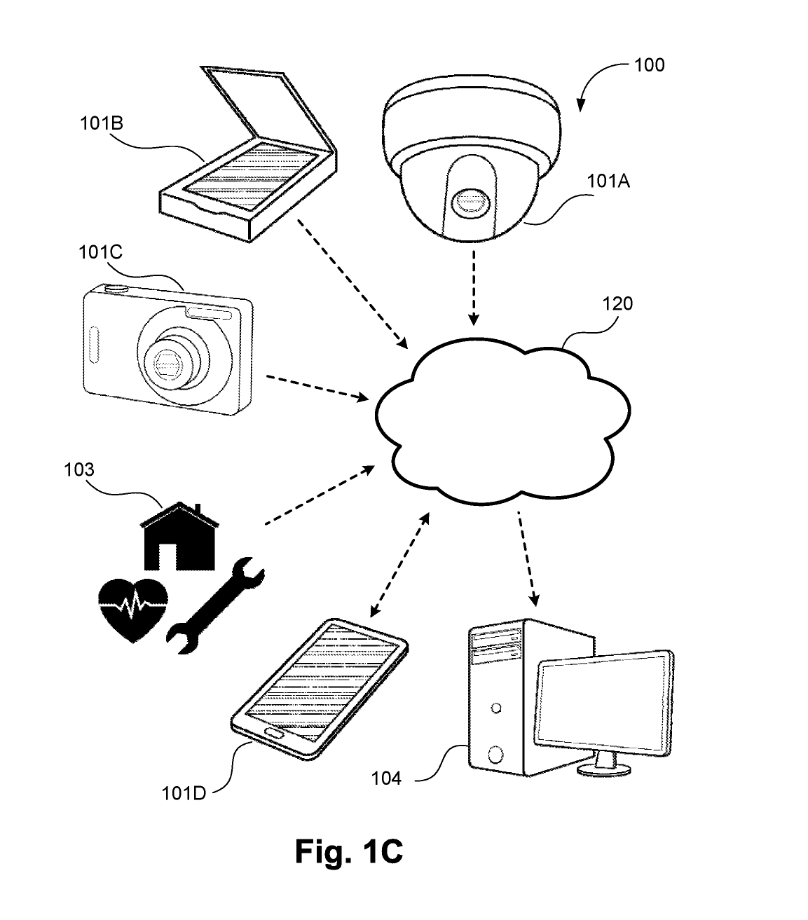

FIGS. 1A and 1B collectively form a schematic block diagram of a general purpose electronic device 101 including embedded components, upon which methods to be described below are desirably practiced.

FIG. 1C shows several of the electronic devices 101A, 101B, 101C and 101D connected to one another, via a communications network 120. The communications network 120 may be a wide-area network (WAN), such as the Internet, a cellular telecommunications network, or a private WAN.

As seen in FIG. 1C, the electronic device 101 may be any suitable apparatus including, for example, a network video camera 101A, scanner 101B, a digital camera 101C and a handheld computing tablet 101D, in which processing resources are limited. Nevertheless, the methods to be described may also be performed on higher-level devices (or apparatus) such as a desktop computer 104, server computers (not shown), and other such devices with significantly larger processing resources. As seen in FIG. 1C, the computer 104 is also shown connected to the network 120.

The electronic devices 103, 101A, 101B, 101C and 101D, will be generically referred to below as the electronic device 101 unless one of the electronic devices 101A, 101B, 101C and 101D is explicitly referred to.

As seen in FIG. 1A, the electronic device 101 comprises an embedded controller 102. Accordingly, the electronic device 101 may be referred to as an “embedded device.” In the present example, the controller 102 has a processing unit (or processor) 105 which is bi-directionally coupled to an internal storage module 109. The storage module 109 may be formed from non-volatile semiconductor read only memory (ROM) 160 and semiconductor random access memory (RAM) 170, as seen in FIG. 1B. The RAM 170 may be volatile, non-volatile or a combination of volatile and non-volatile memory.

The electronic device 101 includes a display controller 107, which is connected to a video display 114, such as a liquid crystal display (LCD) panel or the like. The display controller 107 is configured for displaying graphical images on the video display 114 in accordance with instructions received from the embedded controller 102, to which the display controller 107 is connected.

The electronic device 101 also includes user input devices 113 which are typically formed by keys, a keypad or like controls. In some implementations, the user input devices 113 may include a touch sensitive panel physically associated with the display 114 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 1A, the electronic device 101 also comprises a portable memory interface 106, which is coupled to the processor 105 via a connection 119. The portable memory interface 106 allows a complementary portable memory device 125 to be coupled to the electronic device 101 to act as a source or destination of data or to supplement the internal storage module 109. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 101 also has a communications interface 108 to permit coupling of the device 101 to the communications network 120 via a connection (e.g., 121). The connection 121 may be wired or wireless. For example, the connection 121 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the electronic device 101 is configured to perform some special function. The embedded controller 102, possibly in conjunction with further special function components 110, is provided to perform that special function. For example, where the device 101 is the digital camera 101C, the components 110 may represent a lens, focus control and image sensor of the camera. The special function components 110 are connected to the embedded controller 102. As another example, the device 101 may be a mobile telephone handset. In this instance, the components 110 may represent those components required for communications in a cellular telephone environment. Where the device 101 is a portable device or portable apparatus, the special function components 110 may represent a number of encoders and decoders of a type including Joint Photographic Experts Group (JPEG), (Moving Picture Experts Group) MPEG, MPEG-1 Audio Layer 3 (MP3), and the like.

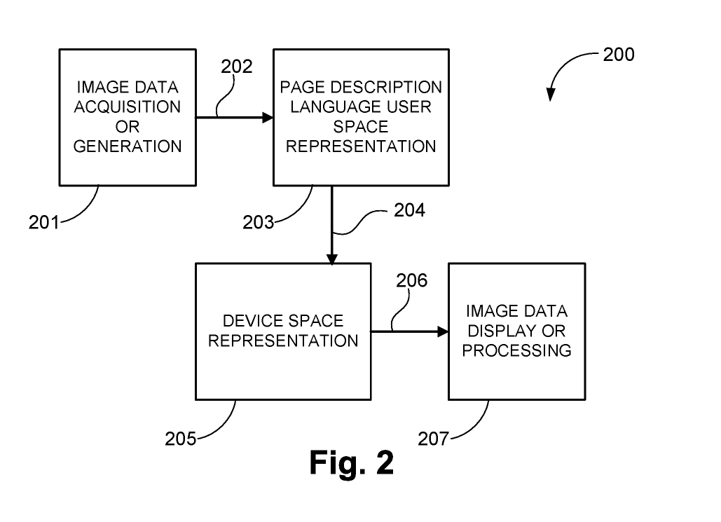

The methods described hereinafter may be implemented using the embedded controller 102, where the processes of FIGS. 2A to 4 may be implemented as one or more software application programs 133 executable within the embedded controller 102. The electronic device 101 of FIG. 1A implements the described methods. In particular, with reference to FIG. 1B, the steps of the described methods are effected by instructions in the software 133 that are carried out within the controller 102. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 133 of the embedded controller 102 is typically stored in the non-volatile ROM 160 of the internal storage module 109. The software 133 stored in the ROM 160 can be updated when required from a computer readable medium. The software 133 can be loaded into and executed by the processor 105. In some instances, the processor 105 may execute software instructions that are located in RAM 170. Software instructions may be loaded into the RAM 170 by the processor 105 initiating a copy of one or more code modules from ROM 160 into RAM 170. Alternatively, the software instructions of one or more code modules may be pre-installed in a non-volatile region of RAM 170 by a manufacturer. After one or more code modules have been located in RAM 170, the processor 105 may execute software instructions of the one or more code modules.

The application program 133 is typically pre-installed and stored in the ROM 160 by a manufacturer, prior to distribution of the electronic device 101. However, in some instances, the application programs 133 may be supplied to the user encoded on one or more CD-ROM (not shown) and read via the portable memory interface 106 of FIG. 1A prior to storage in the internal storage module 109 or in the portable memory 125. In another alternative, the software application program 133 may be read by the processor 105 from the network 120, or loaded into the controller 102 or the portable storage medium 125 from other computer readable media. Computer readable storage media refers to any non-transitory tangible storage medium that participates in providing instructions and/or data to the controller 102 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 101. Examples of transitory or non-tangible computer readable transmission media that may also participate in the provision of software, application programs, instructions and/or data to the device 101 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 133 and the corresponding code modules mentioned above may be executed to implement one or more graphical user interfaces (GUIs) to be rendered or otherwise represented upon the display 114 of FIG. 1A. Through manipulation of the user input device 113 (e.g., the keypad), a user of the device 101 and the application programs 133 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 1B illustrates in detail the embedded controller 102 having the processor 105 for executing the application programs 133 and the internal storage 109. The internal storage 109 comprises read only memory (ROM) 160 and random access memory (RAM) 170. The processor 105 is able to execute the application programs 133 stored in one or both of the connected memories 160 and 170. When the electronic device 101 is initially powered up, a system program resident in the ROM 160 is executed. The application program 133 permanently stored in the ROM 160 is sometimes referred to as “firmware”. Execution of the firmware by the processor 105 may fulfil various functions, including processor management, memory management, device management, storage management and user interface.

The processor 105 typically includes a number of functional modules including a control unit (CU) 151, an arithmetic logic unit (ALU) 152, a digital signal processor (DSP) 153 and a local or internal memory comprising a set of registers 154 which typically contain atomic data elements 156, 157, along with internal buffer or cache memory 155. One or more internal buses 159 interconnect these functional modules. The processor 105 typically also has one or more interfaces 158 for communicating with external devices via system bus 181, using a connection 161.

The application program 133 includes a sequence of instructions 162 through 163 that may include conditional branch and loop instructions. The program 133 may also include data, which is used in execution of the program 133. This data may be stored as part of the instruction or in a separate location 164 within the ROM 160 or RAM 170.

In general, the processor 105 is given a set of instructions, which are executed therein. This set of instructions may be organised into blocks, which perform specific tasks or handle specific events that occur in the electronic device 101. Typically, the application program 133 waits for events and subsequently executes the block of code associated with that event. Events may be triggered in response to input from a user, via the user input devices 113 of FIG. 1A, as detected by the processor 105. Events may also be triggered in response to other sensors and interfaces in the electronic device 101.

The execution of a set of the instructions may require numeric variables to be read and modified. Such numeric variables are stored in the RAM 170. The described methods use input variables 171 that are stored in known locations 172, 173 in the memory 170. The input variables 171 are processed to produce output variables 177 that are stored in known locations 178, 179 in the memory 170. Intermediate variables 174 may be stored in additional memory locations in locations 175, 176 of the memory 170. Alternatively, some intermediate variables may only exist in the registers 154 of the processor 105.

The execution of a sequence of instructions is achieved in the processor 105 by repeated application of a fetch-execute cycle. The control unit 151 of the processor 105 maintains a register called the program counter, which contains the address in ROM 160 or RAM 170 of the next instruction to be executed. At the start of the fetch execute cycle, the contents of the memory address indexed by the program counter is loaded into the control unit 151. The instruction thus loaded controls the subsequent operation of the processor 105, causing for example, data to be loaded from ROM memory 160 into processor registers 154, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 133, and is performed by repeated execution of a fetch-execute cycle in the processor 105 or similar programmatic operation of other independent processor blocks in the electronic device 101.

In the example of FIG. 1A, the devices 101 include the network video camera 101A, scanner 101B capable of scanning documents and photos, the digital camera 101C and the handheld computing tablet 101D.

Also shown connected to the network 120 are one or more network-connected sensors 103, for example, health sensors, device maintenance status sensors, or home automation sensors. In one arrangement, one or more of the sensors may have a similar configuration to the electronic devices 101. Alternatively, one or more of the sensors 103 may have a simpler configuration than the electronic devices 101 for implementing basic communication protocols (e.g., ‘Internet of Things’). The sensors 103 are electronic devices themselves and do not need to be embedded in the other electronic devices 101. As described below, one or more steps of the processes of FIGS. 2A to 4 may be implemented by the sensors 103.

Amongst the electronic devices 101A-101D and 103 of the example of FIG. 1C, there are device capabilities including ability to acquire, artificially generate, send, receive and display image data. Connectivity of the devices 101A-101D, 103 and 104 via the communications network 120 is represented by arrows, with the direction of the arrow indicating the direction in which image data may be sent. In the example of FIG. 1C, the network camera 101A, scanner 101B and network-connected sensors 103 are capable of acquiring or generating image data and sending the image data via the communications network 120, while the desktop PC 104 is capable of receiving image data and displaying the image data. The handheld computing tablet 101D includes an integrated camera, and is capable of all the above functions, both sending and receiving image data via the communications network 120.

In the example of FIG. 1C, interchange of data between the devices 101A-101D, 103 and 104 takes place in the format of a device independent page description language document. That is, image creating devices, including the network camera 101A, scanner 101B, digital camera 101C, tablet 101D and sensors 103, package captured or generated image data as an electronic document. The electronic document may have one or more pages of content in any suitable standardised format. As well as the actual image data, the packaged electronic document may contain other auxiliary content or drawing data. For example, network camera 101A may produce an entire report for surveillance events during a time period, with multiple images captured in response to several security events, with text captions recording time of capture. Advantageously, the entire report, including many images, may be provided as a single artefact which is sharable to other devices (and users of those other devices) connected to the network 120.

In the example of FIG. 1C, the electronic devices 101A-101D and 103 are low cost devices. As such, the electronic devices 101A-101D and 103 connected to the network 120 may be extremely limited as to the processing power and/or memory resources available to the electronic devices 101A-101D and 103. The memory resources in the devices 101A-101D and 103 are typically far less than are required to buffer an entire captured image, or export a full device independent document suitable for exchange between other devices connected to the network 120. Because of the memory resources limitations, the electronic devices 101A-101D and 103 typically store portions of a captured or generated image. During image capture or generation, a partial image data buffer configured for example within the memory 109 of the device 101A is filled with image data, and simultaneously, another partial image data buffer is serialised out to another device (e.g., desktop PC 104) connected to the network 120. When all of the image data in one partial image buffer is serialised and exported, that partial image buffer then becomes available to be re-used by subsequent fill-and-export cycles. Such a buffering method is termed “ping pong buffering”. However, other buffering methods may also be used.

Additionally, due to limited processing resources and limited memory of electronic devices (e.g., 101A-101D, 103), each exported image portion is independently encoded. That is, parameters for compressing the image data and encoding the image data are re-initialised separately for each image portion of an image, rather than forming a single continuous encoded image.

As a result, the exported form of the image data is represented, by declarative elements in the page description language described below, as a series of independent images. Each independent image is independently positioned with respect to one another in a coordinate space using commands in the device independent page description language. The capabilities of the electronic device 101 and page description language effect the level of precision and accuracy which can be achieved. Although it is intended that a resulting set of images appear as a single image captured or generated by the electronic devices 101A, 101B, 101C, 101D or 103, limitations in mathematical precision and accuracy of the electronic devices 101A, 101B, 101C, 101D or 103, combined with limitations of the page description language, may result in small inaccuracies such that one or more of the independent images in the set of independent images do not abut precisely.

Due to the flexible capabilities of multi-page device independent page description languages such as PDF and XPS, the electronic devices 101A, 101B, 101C, 101D and 103 are free to determine the size, position and layout of one or more captured or generated images on each page the electronic device 101A, 101B, 101C, 101D or 103 generates within each serialised electronic document (e.g. a network video camera 100A may serialise a “before” and “after” video frame image for an event on either one page or two). For simplicity the following description describes the processing of a single captured or generated image, but logically and unambiguously extends to any number of captured or generated images on a page.

FIG. 2 shows a data flow 200 for image data from an acquisition stage on a first device (e.g., 101A, 103) to a display stage on a second device (e.g., 101D), via an encoding as a page description language (PDL) document.

At an image data acquisition step 201, the electronic image device 101 acquires or generates image data, under execution of the processor 105. For example, in scanner 101A, a document scanning element is physically moved across the glass platen, and optically captures at least a portion of an image of a document placed upon the platen. In the network camera 101A, or handheld digital camera 101C, image data is captured optically onto an imaging sensor.

Image data acquisition performed at step 201 may also include generation of image content instead of capturing an image. For example, a home automation security device (e.g., 103) may generate an artificial computer generated image based on data from other types of sensors.

When the image data is acquired at step 201, the display characteristics of any image display device connected to the network 120 are not known, or even required to be specified. The acquired image data is subsequently transformed, under execution of the processor 105, to a page description language (PDL) user space representation form 203 in a PDL coordinate space. The PDL coordinate space is a device independent abstract user space co-ordinate system employed by the page description language. The acquired image data is transformed to the PDL user space representation 203 according to an image data transformation process performed at 202.

In the image data transformation process performed at 202, position and size attributes of each independent image representing at least a portion of an image are transformed from the measurement units employed by the first device (e.g., 101A), to the abstract device independent user space co-ordinate system employed by the page description language (i.e., the PDL coordinate space). Loss of accuracy and precision may occur during the transformation process performed at 202 due to processing resource limitations in the first device. For example, the accumulated transformed co-ordinate at which to encode each image portion may be tracked using only integer arithmetic, depending on processing capabilities of the first device. In other cases, accumulation of rounding errors may introduce position errors in a document encoded in an abstract device independent user co-ordinate system employed by the page description language (PDL). Furthermore, the page description language itself may place limitations on the represented accuracy, or there may be a loss of accuracy due to a transformation from binary encoded units to an ASCII representation.

In FIG. 2, the data flow 200 then performs another transformation at 204 to a device space representation 205 of the image data. The transformation performed at 204 is carried out to prepare the independent image data to be displayed on a particular display of the second device (e.g., 101D), suitable for the display characteristics of the second device (e.g., 101D). Encoded image characteristics, such as position and size, are transformed from the abstract device independent user space co-ordinate system employed by the page description language at 203, to a device space co-ordinate system in which the co-ordinate values directly correspond to displayable pixel locations in the specific display of the second device (e.g., 101D) being employed. The transformation performed at 204 may be a further source of loss of accuracy and precision of image attributes, with similar causes as described previously for the transformation process performed at 202.

Then the image data undergoes an image rendering process or other processing at step 206 under execution of the processor 105 of the second device. The image rendering process or other processing transforms the device space representation 205 of the independent images into actual device pixels (e.g., possibly for display at 207), which may result in further losses of accuracy and precision. In some cases, the image does not need to be displayed at step 207, and the image may be otherwise represented so that a user or machine can understand the image. For example, a descriptive explanation of the image can be audio represented to a visually impaired user. Alternatively another electronic device may automatically process the image to extract information or metadata, or to transform the image for other purposes.

The net effect of the various image data transformation processes that occur in data flow 200 is that the independent images, each representing at least a portion of an image representing the captured image data, encoded in the exported device independent page description language document introduce discontinuities in the representation of the captured image data. Discontinuities are spatial (i.e. gaps or overlaps between independent images) which can lead to errors in later machine processing algorithms (e.g. OCR algorithms) or user understanding (e.g. navigation by a visually impaired user), as well as being unsightly and distracting when rendered.

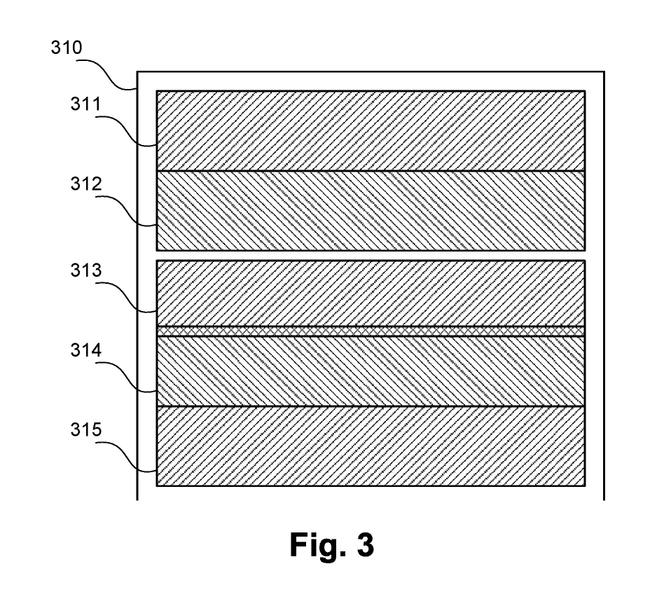

The discontinuities described above may become manifest as will now be described with reference to FIG. 3. FIG. 3 shows a partial view of an example displayed document page 310 containing displayed image data for one or more images. The image data of the page 310 is encoded as independent images (or ‘bands’) 311 through 315. Each of the bands 311 to 315 represents a portion of image data for the page 310.

In the example of FIG. 3, image 311 and 312 are displayed as abutting images, but loss of precision and accuracy has caused the position of image 313 with respect to the image 312 to be shifted such that a visible gap, in device space, appears between images 312 and 313. The visible gap allows one or more pixels (in device space) of background elements (or empty display medium) to be displayed, forming an unsightly discontinuity in the displayed appearance of the captured image data.

Furthermore, in the example of FIG. 3, a loss of precision and accuracy has resulted in images 313 and 314 being positioned, in device space, such that the images 313 and 314 overlap. In the example of FIG. 3, displayed appearance of the captured image data also exhibits a type of discontinuity.

In the example of FIG. 3, the independent images (or ‘bands’) are horizontal, and arranged in a sequence that progress vertically down the page 310, differing in a y co-ordinate image attribute value. An electronic device such as the device 101D is not limited to exporting an image in such a configuration. Independent images each representing at least a portion of an image may be arranged as vertical strips that differ in an x co-ordinate image attribute value, or may be arranged at any other intermediate angle and proceeding in a diagonal progression. Furthermore, the independent images may be arranged in multiple rows and columns as a tiled arrangement.

The existence of independently encoded images also gives rise to other types of discontinuities in original image data. The device independent page description language document may further subject independent image data corresponding to a portion of the captured image to an image processing operation, which will then exhibit a different result than if the image data had been encoded as a single image. For example, in a Gaussian blur image processing operation, image data is processed such that pixels within a vicinity of a location are combined according to a mathematical operation to form a processed pixel result. At the edges of each independent image, pixels from other abutting independent images do not contribute to the blurred result. Therefore, an image discontinuity is exhibited at locations within the captured image where there are internal boundaries between the independent images.

A further type of displayed image discontinuity may be exhibited when the independent images are subsequently re-encoded with varying image encoding parameters (such as a level of lossy image compression to be applied). Re-encoding may be required to better utilise resources available on a rendering device, (e.g. to satisfy memory limits), to compress the output PDL document, to encrypt the output PDL document or a portion of the PDL document etc. The displayed image then includes discontinuities manifest as boundaries between the independent images with varying image quality.

An original image, encoded as multiple independent images in a device independent page description language presents further difficulties related to the semantic meaning of the image and context of the original image within the document. For example, some document standards require every image to have an alternate descriptive representation, to be made available to assistive technologies utilised by users with impairments. If the single original image is instead represented as multiple independent images, then redundant alternate representations may result, which may disrupt the proper operation of such software adapted for users with accessibility requirements.

Some document display software may adjust or reflow document contents to be displayed or otherwise processed, generating a situation in which the independent images of a single original image are broken up and displayed in a re-arranged manner.

As described in detail below, in order to prevent the introduction of image discontinuities, the independent images (corresponding to a single original image captured or generated by an electronic imaging device) may be processed as though the independent images were instead a single unified logical image. Each independent image corresponds to a ‘portion’ of the single unified logical image. The single unified logical image may also be referred to as a ‘semantic unit’.

According to one arrangement, an image marking PDL data structure is utilised such that independent images are declared as forming a single unified logical image. As described below, an attribute identifying that one of the independent images forms part of the unified logical image may be used.

An example sequence of page content drawing commands provided in the PDF page description language, according to one arrangement, is shown in Appendix A. As described above, the PDF page description language defines a hierarchy of page description language (PDL) objects.

The example of Appendix A shows a sequence of declarations of independent inline image objects. Each independent image object corresponds to one independent image defined within BI (begin image), ID (image data) and EI (end image) operators, enclosed in a marked content section. Each marked content section refers to an original image, with a plurality of marked content sections referring to a plurality of corresponding original images. Some detail has been omitted from the example of Appendix A or generalised in the example for brevity.

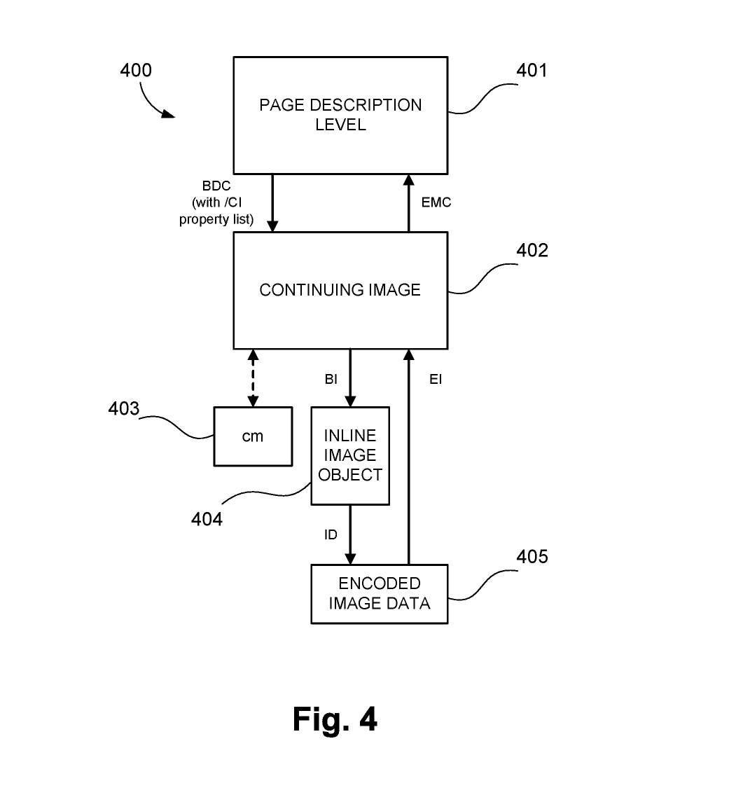

FIG. 4 shows a state diagram 400 representing generation of a page description language data structure for declaring a plurality of independent image objects that are to be processed as a single unified logical image. The unified logical image may be referred to as a semantic unit.

State diagram 400 has states connected with transitions that are associated with certain commands defined in a page description language taking the form of serialised object declarations and drawing commands. According to one arrangement, the electronic device 101 initiates output of a device independent page description document. The output initiation of the device 101 may be in response to an internal or external trigger, timeout, sensor input, or any other event. As described above, due to the processing and memory limitations of the electronic device 101, the full electronic document may not be able to be buffered and is instead serialised out to another device on the network 120.

At some point within a document defined in a page description language, the current state is a page description level state 401, at which there exists an object declaration representing a page within the document. Within the page of the document, there may be any variety of object declarations or drawing commands to produce displayed output data associated with that page of the document. According to one arrangement, a BDC operator associated with a /CI (continuing image) object declaration, indicating the start of a marked content section that is a continuing image declaration, and the page description language data description undergoes a state transition to continuing image state 402. A page may contain many such marked content sequences, each representing a semantically distinct image that was serialised by the electronic device. For example, if the device 101 intends to place a captured or generated image as a single semantic unit in a report represented by a PDF document, the device 101 moves to continuing image state 402. Given that the device 101 knows that the captured image is to be a single semantic unit, even before the device 101 writes out the first image portion for that captured image, the device 101 is able to mark all image portions, being encoded as independent images, as belonging to a single logical image. An example of marking the independent images is encapsulating the independent images and the appropriate position commands into a marked content section of a generated PDF document. The device 101 stays at the continuing image state 402 until all independent images for that single semantic unit are included into the marked content section for that semantic unit. When a further captured or generated image needs to be placed in the report, the device 101 moves to continuing image state 402 and opens a new marked content section for the further captured or generated image within the PDL data structure. While in the continuing image state 402, the device 101 follows the process as described above, so that independent images corresponding to two different semantic units are each marked as belonging to two distinct marked content sections.

While at continuing image state 402, the page description language data structure has object declarations defining a sequence of independent images, each independent image object having an associated image placement command. In the example page description language data structure above, an image placement command is performed by the PDF cm operator which applies the given co-ordinate transformation to the current transformation matrix stored within the PDF graphics state, and is represented as state 403 as shown in FIG. 4. The PDF BI operator signifies the start of an inline image object declaration, and is associated with a state transition to an inline image object state 404. During state 404, a number of declarations signifying properties of the data for the inline image appear. The properties may include, for example, number of image pixels in each scanline, number of scanlines, bit depths and color channels, semantic meaning, and a type of encoding for the actual image data that follows. The PDF ID operator signifies the start of encoded image data for the currently declared inline image object, and is associated with a state transition to an encoded image data state 405. During state 405, the encoded image data appears. The encoded image data is terminated by a PDF EI operator, associated with a state transition back to state 402. Further independent image declarations then follow, each with an independent image placement command as required by the page description language. By means of iterative declarations of inline images with associated image placement commands, a sequence of independent images are placed within the vicinity of one another, forming a unified logical image.

Each inline image serialised by the electronic device 101 is the serialisation of the partial image data in one of the “ping pong” buffers previously described. The set of independent images and corresponding independent image objects, representing a single unified image, may all be subject to further geometrical transformations declared outside of the data structure for the unified image. For example, the entire sequence is subject to an additional transformation that places the unified logical image in an arbitrary location or scale on the document page, or rotates the unified logical image, such as to account for a wall or roof mounted camera.

Following the end of all of the independent object declarations, a PDF EMC operator signifies the end of the marked content section, and is associated with a return to state 401.

In an alternative example, the PDL data structure for the unified logical image utilises references to image declarations that are defined elsewhere, rather than occurring inline within the PDL data structure itself. For example, in the PDF page description language, ‘image XObjects’, which are independent image objects in the PDF object hierarchy, may be used. The PDF page description language describes a document as a hierarchy of PDL objects. In the image XObject arrangement, each image XObject is positioned with a PDF cm operator similarly to inline images, and then painted with the PDF Do operator. In a similar manner to inline images described above, the PDF cm operators place the independent image XObjects in the vicinity of one another to form a unified logical image as shown by way of example in Appendix B. The page description language (PDL) data structure for the example unified logical image shown in Appendix B defines a hierarchy of XObjects. The XObjects are hierarchically organised to form the unified logical image as seen in Appendix B.

When serialising image data (as in data transformation step 202), the electronic device 101 outputs one or more original images each represented by a set of corresponding independent image objects enclosed by the markers for the beginning and end of the marked content section and associated drawing commands that defines the marked content section as encoding a single unified logical image. The electronic device 101 may emit independent images according to a usage pattern of available memory resources utilised by the device 101 in the operation of acquiring the image data.

When processing image data (as in step 206), the electronic device 101 encountering a marked content section associated with the BDC operator with a /CI tag shall invoke a rendering mode in which the combined image data of state 207 is produced such that the independent images form a single unified logical image.

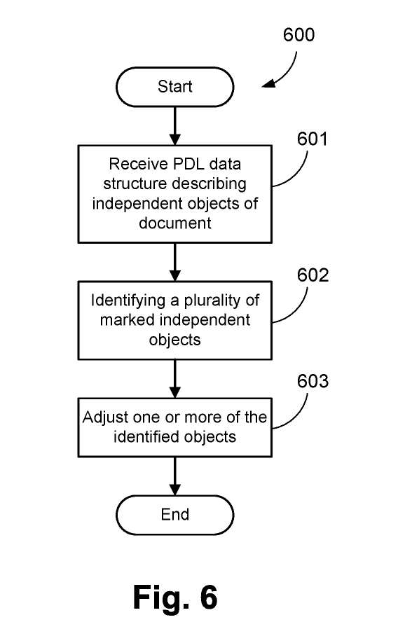

A method 600 of processing a document described by a page description language (PDL) data structure will now be described with reference to FIG. 6. The document to be processed is described by a PDL data structure described in a PDL coordinate space as described above. The method 600 enables displayed image discontinuities, logical discontinuities and/or semantic discontinuities to be avoided by treating independent image objects of the page description language data structure as a single unified logical image. As described in detail below, each independent image object comprises image data of a corresponding independent image together with attributes of the independent image.

The method 600 may be executed as one or more software code modules of the program 133 resident in the storage module 109 of the device 101 and being controlled in its execution by the processor 105. In an alternative arrangement, one or more steps of the method 600 may be implemented by one or more of the network-connected sensors 103.

The method 600 begins at receiving step 601, where the PDL data structure describing independent image objects of the document being processed is received under execution of the processor 105, each of the independent image objects being individually described in the PDL data structure by associating image data with at least one attribute of the corresponding independent image object. For example, the image data for an independent image (e.g., 311) may be associated with an x co-ordinate image attribute value of the corresponding independent image. As also described above, each independent image object is independently placed in the PDL coordinate space using commands in the device independent page description language.

The method 600 then proceeds to identifying step 602, where a plurality of the independent image objects marked, in the PDL data structure, as forming a unified logical image, are identified. As described above, the independent image objects are enclosed by the markers for the beginning and end of the marked content section and associated drawing commands that define the marked content section as encoding a single unified logical image. In response to detecting the begin marker, a PDL interpreter initialises a new context for building the unified logical image. Once the end marker is detected, the PDL interpreter closes the context, so that subsequent independent image objects are processed independently, not as part of a unified logical image.

Then at adjusting step 603, one or more of the identified independent image objects are adjusted independently of each other based on the corresponding attributes. A number of arrangements shall now be described, in which one or more of the independent image objects are adjusted in order to allow consistent processing of the unified logical image. As described, the marked independent image objects are adjusted independently of one another.

The independent image objects, each representing an independent image, may be adjusted spatially (e.g., scaling and extrusion). Consistent image compression may also be performed on each independent image for a plurality of independent image objects. Semantic tagging and metadata may also be applied to the single unified logical image.

In one arrangement, an image placement attribute of an independent image object is adjusted in order for the unified logical image to be consistently processed. Upon invoking an adapted rendering mode for consistently processing independent image objects as a single unified logical image, a renderer module (e.g., implemented as one or more code modules of the program 133) detects the presence of a gap or overlap between abutting independent images in the device co-ordinate space for the electronic device 101 on which the image data is to be displayed (as at 207). For example, in FIG. 3, the gap occurs between images 312 and 313, and the overlap occurs between images 313 and 314. In such an adapted rendering mode, an image placement attribute of an independent image object corresponding to an independent image is then adjusted such that the neighbouring independent images abut precisely without a gap or overlap. As such, placement of one of the marked independent image objects may be adjusted based on placement of at least one other of the marked independent image objects.

The image placement attribute may be adjusted by modifying a position attribute or scaling attribute. For example, in order to avoid a discontinuity that arises from a gap, one or both images adjacent to the gap may be slightly stretched in order to fill in the device space pixels of the gap. Such an operation may invoke rendering processing causing an image sampling or interpolation filtering operation to be performed on the image data. It is undesirable to simply shift the position of subsequent independent images once a gap or overlap is detected, as this can alter dramatically the overall dimensions of the unified image when many independent images are altered. In the device independent page description document, other graphics or text may have been placed relative to the unified image (e.g., rectangle graphics indicating face detection in a camera image or the date and time of the image capture). If the unified image is dramatically altered then the additional graphics will be incorrectly placed or possibly obscured.

In some arrangements, discontinuities that arise from gaps or overlaps between independent images are avoided by making multiple adjustments to the image placement attributes of multiple independent image objects, each representing corresponding independent images, such that the inaccuracy introduced by any single independent image contributes to adjustments throughout many (or all) of the independent image objects in data structure. As described above, adjustments may include position, scaling, stretching or interpolating one or more of the independent images. Furthermore, two or more of the independent images and corresponding independent image objects may be adjusted differently.

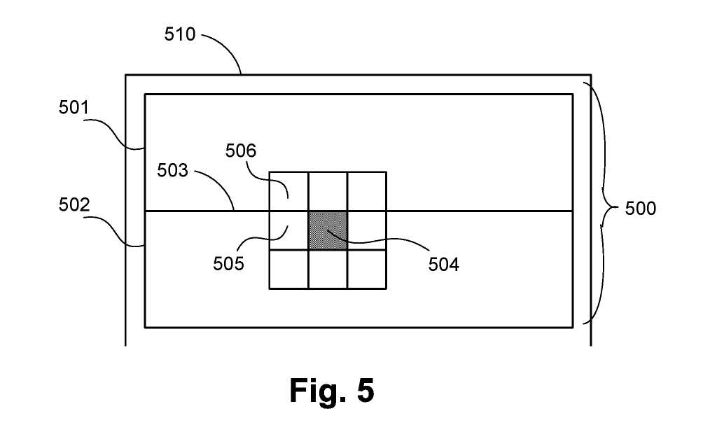

In a further arrangement, an image extrusion attribute of an independent image is adjusted in order for the unified logical image to be consistently processed. FIG. 5 shows a partial view of an example displayed document page 510, having two adjacent independent images 501 and 502. Each of the independent images 501 and 502 is represented by a corresponding independent image object in accordance with the page description language data structure described above. In the example of FIG. 5, the final appearance of the independent images 501 and 502 is to be consistently processed as a single unified logical image 500, and is subject to a pixel-level filtering operation to be applied to the displayed appearance of the single unified logical image 500. An image location 504 falls within independent image 502, and is adjacent to boundary 503 shared by the abutting images 501 and 502. The rendered appearance for image location 504, according to the specified image filtering operation, is derived by means of a mathematical function of the image location 504 and surrounding image locations. Surrounding image locations may be located within the same image section 502 (e.g., image location 505), or may be located within the adjacent image 501 (e.g., image location 506).

When applying such an image filter to independent image 502, the displayed image value for location 504 at the boundary is derived by extruding image data for locations along the boundary 503. That is, for the purposes of applying the image filter, image location 506 that falls outside the image 500 shall be considered to have an image value equal to or derived from the image value for adjacent image location 505 located within the image section 502. According to an arrangement, an extrusion attribute of independent image object for one independent image is adjusted such that for the purposes of applying an image filtering operation to independent image 502, a value for image location 506 is sampled from the corresponding adjacent location within adjacent independent image 501. Therefore, the independent images are consistently processed as a unified logical image 500, and a discontinuity that would arise at the boundary between adjacent independent images is avoided.

The processing of independent image objects as a unified logical image as described above may be generalised to be applicable in certain cases. For example, the processing of independent image objects as a unified logical image may be applied where a filtered image value is required for an image location in the vicinity of image boundary 503, but not directly adjacent to the boundary 503, where the extent of image locations contributing to the image filtering operation has a reach extending into an adjacent independent image. Image filters for which the described method of processing independent image objects as a unified logical image may be applied include, for example, blurring filters, Gaussian filters, and sharpening filters.

Additionally, in some arrangements, filters for performing sampling or interpolation of the resolution of an image may use the described method, as is required for rendering modes adjusting an image placement attribute of an independent image in order to produce consistently processed displayed image data.

In yet a further arrangement, a compression attribute of an independent image object for an independent image is adjusted in order for the unified logical image to be consistently processed. For example, at 306 as shown in FIG. 2, image data is prepared for display by rendering the device space representation of the image data. A renderer module implemented by the program 133 executing on the electronic device (e.g., computing device 104) may internally subject image data to further compression in order to optimise performance or resource utilisation. The renderer module may consider each independent image separately when selecting appropriate compression attributes for an image, based on image properties detected for each independent image. In such an arrangement using the compression attribute, the displayed collective result of the independent images may exhibit discontinuities at the boundaries of the independent images, for example, by the appearance of different types of compression artefacts that are dependent upon the compression attributes selected such as quality level and type of compression.

A processing parameter associated with one of the marked independent image objects may be adjusted based on a corresponding processing parameter of at least one other of the marked independent image objects. For example, according to one arrangement, the independent image objects forming the page description language data structure for the unified logical image are analysed collectively as a whole when selecting a compression type and compression attributes, rather than determining a compression type for each independent image object individually. The same type and attributes may be consistently applied to each independent image object and corresponding independent images when performing an internal compression operation during step 206 associated with rendering image data for the independent images to be displayed. Therefore, a compression attribute of one or more of the independent image objects are adjusted in order to allow the unified logical image to be consistently processed. For example, each independent image object should have the same lossy compression factor applied to avoid edge artefacts at independent image boundaries. Such consistent image compression processing applies for electronic devices which desire to reduce the overall size of the serialised PDL document through better image compression algorithms.

The aforementioned arrangement in which a compression attribute of an independent image object representing a corresponding independent image is adjusted may be extended to other types of attributes. For example, in another analogous arrangement, a colour space attribute of an independent image object may be adjusted in order for the unified logical image to be consistently processed. As another example, histogram-based colour processing algorithms may process the combined histogram from all independent images comprising the unified image, rather than using the individual histograms from each independent image.

Additional arrangements are now described in which one or more independent image objects of the page description language data structure are adjusted such that the unified logical image is processed in a semantically consistent manner. The state diagram 500 defining the form of the page description language data structure invokes the start of a continuing image section by using a PDF BDC operator with /CI tag and supplying an associated property list. The property list supplies any number of dictionary keys and an associated property value for each key. Any number of attributes may be associated with the unified logical image that results from consistent processing of the independent images declared in the marked content section for the continuing image. Such property list attributes may include, but are not limited to, the overall dimensions of the unified logical image (such as scanner platen size or camera sensor size); or sensor metadata for the unified logical image. The sensor metadata may be more efficiently recorded just once for the unified logical image rather than with each independent image object, and may include data such as global positioning system (GPS) location or date/time.

In one arrangement for semantically consistent processing of the unified logical image, a tag representing an alternative textual description of the unified logical image is defined in the continuing image property list, and thus is applied preferentially over that for each independent image object contained therein. Such alternative text is applicable to the operation of software that provides a text-to-speech audio version of a document for users with visual impairment. The unified logical image is processed consistently by ignoring the alternative text attributes for the independent image objects.

In another arrangement, semantically consistent processing of the unified logical image occurs by treating the unified logical image as a single item within the semantic structure of the document. Therefore, any operations that render a displayed form of the document being processed shall not treat the independent images separately. For example, an operation to re-layout or re-flow the document contents to suit a different type of display device may keep all the independent image objects within the vicinity of one another, and not become split apart across different pages or regions of the display. In a further example, an operation to reflow text within a document shall not cause the text to be positioned such that the independent images no longer form a continuous logical image. This may occur for example if the device independent page description page was originally formatted as landscape A4, but is being viewed on a small screen mobile device in portrait orientation.

### INDUSTRIAL APPLICABILITY

The arrangements described are applicable to the computer and data processing industries and particularly for image processing.

The foregoing describes only some embodiments of the present disclosure, and modifications and/or changes can be made thereto without departing from the scope and spirit of the invention, the embodiments being illustrative and not restrictive.

```
APPENDIX A
............................................................................................................................
/CI << . . . >> BDC
  1 0 0 1 250 400 cm
  BI
    /W . . .
    /H . . .
    . . .
  ID
    . . . binary image data for a first independent image band
  EI
  1 0 0 1 250 600 cm
  BI
  ID
    . . . binary image data for a second independent image band
  EI
  . . . (additional independent image declarations)
EMC
............................................................................................................................
```

```
APPENDIX B
............................................................................................................................
/CI << . . . >> BDC
  1 0 0 1 250 400 cm
  /Im1 Do #image XObject for a first image band
  1 0 0 1 250 600 cm
  /Im2 Do #image XObject for a second image band
  . . . (additional independent image declarations)
EMC
............................................................................................................................
```

1. A method of processing a document described by a page description language (PDL) data structure in a PDL coordinate space, the method comprising:
receiving the PDL data structure describing independent image objects of the document, each of the independent image objects being described in the PDL data structure by associating image data with at least one attribute of the corresponding independent image object, each independent image object being independently placed in the PDL coordinate space;
identifying a plurality of the independent image objects marked, in the PDL data structure, as forming a unified logical image; and
adjusting one or more of the identified independent image objects independently of each other based on the corresponding attributes.

2. The method according to claim 1, wherein at least two of the independent image objects are adjusted differently.

3. The method according to claim 1, wherein placement of one of the marked independent image objects is adjusted based on placement of at least one other of the marked independent image objects.

4. The method according to claim 1, wherein a processing parameter associated with one of the marked independent image objects is adjusted based on a corresponding processing parameter of at least one other of the marked independent image objects.

5. The method according to claim 1, further comprising creating an attribute identifying that at least one of the independent objects forms part of the unified logical image.

6. The method according to claim 1, further comprising creating, within the PDL data structure, a marked content section associating a plurality of independent image objects.

7. An apparatus for processing a document described by a page description language (PDL) data structure in a PDL coordinate space, the apparatus comprising:
receiving module for receiving the PDL data structure describing independent image objects of the document, each of the independent image objects being described in the PDL data structure by associating image data with at least one attribute of the corresponding independent image object, each independent image object being independently placed in the PDL coordinate space;
identifying module for identifying a plurality of the independent image objects marked, in the PDL data structure, as forming a unified logical image; and
adjusting module for adjusting one or more of the identified independent image objects independently of each other based on the corresponding attributes.

8. A system for processing a document described by a page description language (PDL) data structure in a PDL coordinate space, the system comprising:
a memory for storing data and a computer program;
a processor coupled to the memory for executing the computer program, the computer program comprising instructions for:
receiving the PDL data structure describing independent image objects of the document, each of the independent image objects being described in the PDL data structure by associating image data with at least one attribute of the corresponding independent image object, each independent image object being independently placed in the PDL coordinate space;
identifying a plurality of the independent image objects marked, in the PDL data structure, as forming a unified logical image; and
adjusting one or more of the identified independent image objects independently of each other based on the corresponding attributes.

9. A computer readable medium having a computer program stored on the medium for processing a document described by a page description language (PDL) data structure in a PDL coordinate space, the program comprising:
code for receiving the PDL data structure describing independent image objects of the document, each of the independent image objects being described in the PDL data structure by associating image data with at least one attribute of the corresponding independent image object, each independent image object being independently placed in the PDL coordinate space;
code for identifying a plurality of the independent image objects marked, in the PDL data structure, as forming a unified logical image; and
code for adjusting one or more of the identified independent image objects independently of each other based on the corresponding attributes.

10. A method of generating a document described by a page description language (PDL) data structure in a PDL coordinate space, the method comprising:
receiving a document comprising one or more pages from an electronic device over a communication network, each page comprising a plurality of semantic units, at least a first one of the semantic units being received as a plurality of independent images;
receiving data from the electronic device identifying that the first semantic unit is represented by the plurality independent images; and
generating the PDL data structure describing at least a page of the document, the PDL data structure defining a hierarchy of PDL objects, wherein the independent images are described in the PDL data structure as independent objects in the PDL data structure, wherein the generated PDL data structure comprises a marked content section for the first semantic unit based on the data received from the device to allow consistent processing to be applied to the plurality of independent images.

11. The method of claim 10, further comprising:
receiving a further data indicating that a second semantic unit is formed by a second plurality of independent images, wherein a second marked content section is created for the second semantic unit, the marked content section being different from the second marked content section.

12. An apparatus for generating a document described by a page description language (PDL) data structure in a PDL coordinate space, the apparatus comprising:
document receiving module for receiving a document comprising one or more pages from an electronic device over a communication network, each page comprising a plurality of semantic units, at least a first one of the semantic units being received as a plurality of independent images;
data receiving module for receiving data from the electronic device identifying that the first semantic unit is represented by the plurality independent images; and
generating module for generating the PDL data structure describing at least a page of the document, the PDL data structure defining a hierarchy of PDL objects, wherein the independent images are described in the PDL data structure as independent objects in the PDL data structure, wherein the generated PDL data structure comprises a marked content section for the first semantic unit based on the data received from the device to allow consistent processing to be applied to the plurality of independent images.

13. A system for generating a document described by a page description language (PDL) data structure in a PDL coordinate space, the system comprising:
a memory for storing data and a computer program;
a processor coupled to the memory for executing the computer program, the computer program comprising instructions for:
receiving a document comprising one or more pages from an electronic device over a communication network, each page comprising a plurality of semantic units, at least a first one of the semantic units being received as a plurality of independent images;
receiving data from the electronic device identifying that the first semantic unit is represented by the plurality independent images; and
generating the PDL data structure describing at least a page of the document, the PDL data structure defining a hierarchy of PDL objects, wherein the independent images are described in the PDL data structure as independent objects in the PDL data structure, wherein the generated PDL data structure comprises a marked content section for the first semantic unit based on the data received from the device to allow consistent processing to be applied to the plurality of independent images.

14. A computer readable medium having a computer program stored thereon for generating a document described by a page description language (PDL) data structure in a PDL coordinate space, the program comprising:
code for receiving a document comprising one or more pages from an electronic device over a communication network, each page comprising a plurality of semantic units, at least a first one of the semantic units being received as a plurality of independent images;
code for receiving data from the electronic device identifying that the first semantic unit is represented by the plurality independent images; and
code for generating the PDL data structure describing at least a page of the document, the PDL data structure defining a hierarchy of PDL objects, wherein the independent images are described in the PDL data structure as independent objects in the PDL data structure, wherein the generated PDL data structure comprises a marked content section for the first semantic unit based on the data received from the device to allow consistent processing to be applied to the plurality of independent images.

15. A computer readable medium storing a page description language (PDL) data structure describing a document in a PDL coordinate space, the page description language data structure comprising:
a plurality of independent image objects, each independent image object being described in the PDL data structure by associating image data with at least one attribute of the corresponding independent image section;
at least one image placement command for each independent image object, the at least one image placement command defining a placement of said independent image object in the PDL coordinate space; and
an image marking data structure for associating the plurality of independent image objects, in the PDL coordinate space, with respect to one another in accordance with the image placement commands, the independent image objects being marked as forming a unified logical image to allow consistent processing of the unified logical image by adjusting the marked independent image objects independently of one another.
